(19) United States
(12) Patent Application Publication
(10) Pub. No.: US 2012/0137835 A1
(43) Pub. Date: Jun. 7, 2012

(54) Adrin leverage ratchet

(76) Inventors: Rafael Miguel Garcia, Florence, OR (US); Adrian Lawerence Poggl, Eugene, OR (US)

(21) Appl. No.: 13/373,082

(22) Filed: Dec. 5, 2011

Related U.S. Application Data
(60) Provisional application No. 61/456,658, filed on Nov. 10, 2010.

(51) Int. Cl. B25B 13/46; B25B 23/16; B25B 13/02

(52) U.S. Cl. 81/60; 81/124.6

(57) ABSTRACT

A standard mechanic's ratchet modified with a square-receiving hole at the bottom of the handle receives the square drive of a second ratchet to provide additional leverage for the removal of nuts and bolts. Existing mechanics ratchets do not have a hole to accept the square drive of a second ratchet. The Adrin Leverage Ratchet provides mechanics with additional leverage for the removal of over-tightened nuts and bolts.

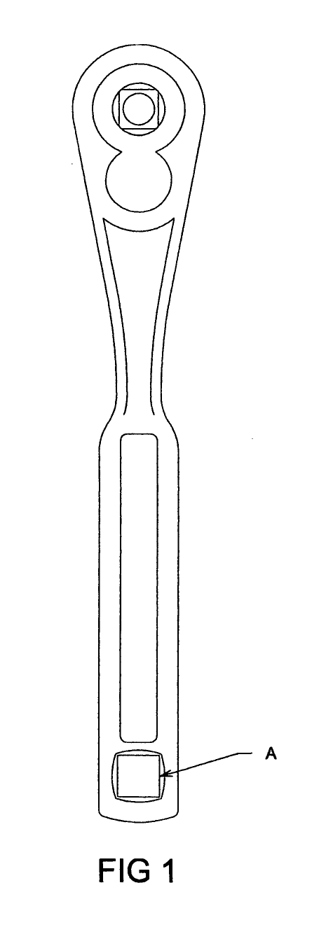

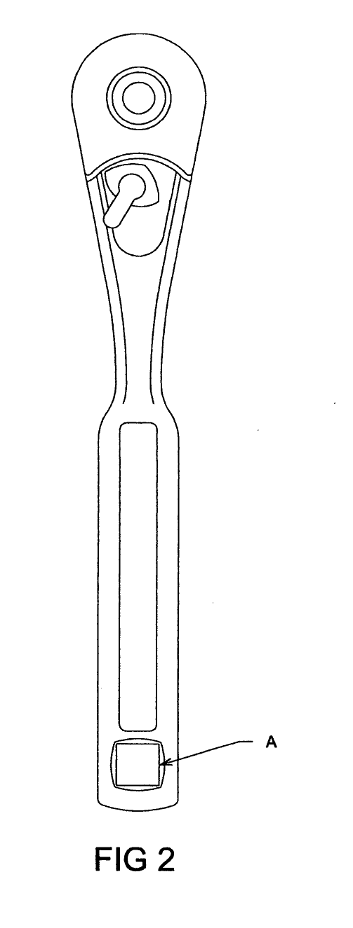

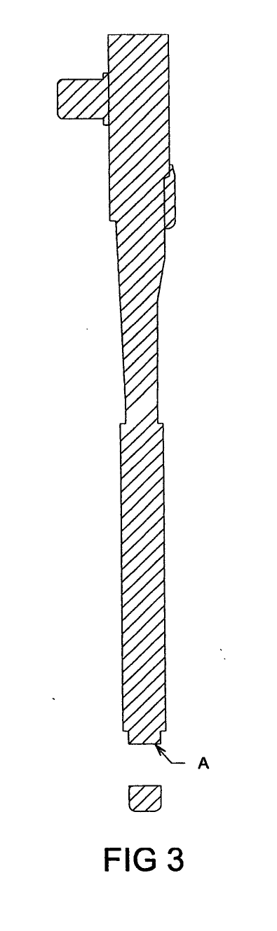

We are claiming priority under our provisional patent number 61/456,656 dated Nov. 9, 2010. And provisional patent number 61/460,306 dated Jan. 3, 2011.

The background of the invention is our mechanical experience which led us to develop a tool that would provide greater leverage and versatility when needing to loosen or tighten tough nuts and bolts.

The Adrin Leverage Ratchet is a ratchet with a square drive receiving hole at the end of the handle of a ratchet. This receiving hole accepts the square drive of a second ratchet, providing additional leverage.

The first sets of drawings are of the Adrin Leverage Ratchet. Drawing One shows the face of the ratchet with the square receiving drive hole at the end of the handle of a ratchet. Drawing Two shows the back of the ratchet with the square receiving drive hole at the end of the handle of a ratchet. Drawing Three shows a side view of the ratchet with the square drive receiving hole at the end of the handle of a ratchet, page 4 describes the first set of drawings. The second sets of drawing are of the Ultimate Wrench.

Drawing One shows the face of the wrench with the square receiving holes on each end. Drawing Two shows the side view of the wrench with the square receiving holes. Page six describes the details.

The Adrin Leverage ratchets unique square drive receiving hole at the end of a ratchet allows users to connect a second regular ratchet to the end of the Adrin Leverage Ratchet for leverage. Both the drive end of the Adrin Leverage Ratchet and the square receiving hole on the end of the handle would be the same size. For example: a ¼ inch drive ratchet would have a ¼ inch drive receiving hole at the end of the handle of the ratchet. The Adrin Leverage ratchet would be a ratchet manufactured with a square drive receiving hole at the end of the handle of the ratchet in drive sizes ¼ inch, ⅜ inch, ½ inch, ¾ inch and 1 inch. Each ratchet would be manufactured with a receiving hole at the end of the ratchet which would be the same size as the drive end of the ratchet. The Adrin Leverage Ratchet is made from hardened steel, alloy, or other extremely tough materials like all other ratchets. The only difference between a standard ratchet and the Adrin Leverage Ratchet is the square drive receiving hole for the square drive of a standard ratchet to be attached.

The Adrin Leverage Ratchet was designed to take the place of using a metal pipe to extend the handle of a ratchet for leverage. Due to shortness of most ratchets, the amount of force exerted is limited by its length. The addition of a second ratchet doubles the amount of leverage. Pipes are generally used to add leverage to a ratchet or wrench. The problem with a pipe is getting it to fit in a tight space. A pipe also fails to provide a secure attachment. When using the Adrin Leverage Ratchet you simply connect a regular ratchet into the square drive receiving hole at the end of the handle.

This eliminates any free play in the tool and allows a variety of angles as well as the leverage needed, which a pipe does not give. The Adrin Leverage Ratchets whole concept is a square drive hole added to the end of the handle of a ratchet or wrench to achieve ultimate leverage and angles to loosen and tighten hard to reach or excessively tight nuts and bolts.

The square-drive receiving hole would be utilized on the Ultimate Wrench. This tool would be a wrench with a square drive receiving hole approximately ½ inch from the box end, and a square drive receiving hole approximately ½ inch from the open-end of the wrench.

1. A new and improved ratchet (The Leverage Ratchet) affords a mechanic additional leverage for the removal of stubborn nuts and bolts.

2. A square-receiving hole at the bottom of the handle has been added to the standard ratchet.

3. The square-receiving hole accepts the square drive end of any standard ratchet which is of the same drive size of the receiving hole.

4. The square-receiving hole is the same dimension as the drive end of the particular size ratchet being used relative to the nut or bolt size.

5. The receiving hole matches the drive end of a one-quarter inch ratchet, or a three-eighths inch ratchet or a one-half inch ratchet, or a three-quarter inch ratchet, or a one-inch ratchet, or a one and one-quarter inch ratchet.

6. Square-receiving holes built into a standard mechanics wrench allow for the insertion of a ratchet drive. The holes are located one-half inch below the open end of the wrench, and one-half inch below the box end of the new Ultimate Wrench.

7. The square-receiving holes built into the wrench handles are sized to match the performance of the wrench. The smaller the wrench, the smaller the receiving hole. The larger the wrench, the larger the receiving hole.
